(19) United States
(12) Patent Application Publication
(10) Pub. No.: US 2009/0307332 A1
(43) Pub. Date: Dec. 10, 2009

(54) Network caching for hierachincal content

(76) Inventor: Louis Robert Litwin, Edison, NJ (US)

Correspondence Address: Thomson Licensing LLC, P.O. Box 5312, Two Independence Way, PRINCETON, NJ, 08543-5312, US

(21) Appl. No.: 11/918,968

(22) PCT Filed: Apr. 22, 2005
(86) PCT No.: PCT/US2005/013715

§ 371 Date: Oct. 22, 2007

(51) Int. Cl. G06F 15/16; G06F 12/08

(52) U.S. Cl. 709/219; 711/118; 711/E12.017

(57) ABSTRACT

A method and apparatus for caching content are described including storing content on a content server, differentiating between pieces of content and storing a portion of the differentiated content at a cache server proximate to a user.

### FIELD OF THE INVENTION

The present invention relates to network caching of content and in particular, to network caching of content that is hierarchical in nature. Content that is hierarchical in nature includes but is not limited to games, multimedia content with associated players and interactive content.

### BACKGROUND OF THE INVENTION

The prior art solutions for efficient use of network resources such as bandwidth and storage include storing content at a content server and additionally as necessary based on some algorithm at cache servers that are closer to a user/customer. Users/customers may additionally have storage locally in their homes/offices. One such system delays delivery of content to off-peak traffic hours in order to more efficiently use network resources.

Systems that do not delay delivery of content need to rapidly and efficiently move content that is not already at a cache server to cache servers where it is most effectively further distributed to users/customers. Current digital download services of non-movie content (e.g., gaming services such as the Phantom gaming console) use an unintelligent download. They download instantaneously using full available bandwidth. This approach is not efficient in terms of storage or bandwidth and does not scale well for a large number of downloads.

What is needed is a system and method for segregating or treating parts or aspects of content differently based on certain criteria in order to more efficiently use network resources such as bandwidth and storage.

### SUMMARY OF THE INVENTION

In some cases and in some systems content delivery is delayed to off-peak traffic hours to more efficiently use network resources. This works well for content such as movies, which are a single entity. However, other types of content such as games are more hierarchical in nature because a “game” consists of several files, e.g., a gaming engine, files for each level of play in the game, files for music and in-game cinematics, etc. More efficient techniques are needed that take into account the nature of the content. The present invention teaches a method and system for treating different parts or aspects of content differently. That is, a method and apparatus for caching content are described including storing content on a content server, differentiating between pieces of content and storing a portion of the differentiated content at a cache server proximate to a user.

### BRIEF DESCRIPTION OF THE DRAWINGS

The present invention is best understood from the following detailed description when read in conjunction with the accompanying drawings. The drawings include the following figures briefly described below where like-numbers on the figures represent similar elements:

FIG. 1 is a block diagram of the present invention.

FIG. 2A is a flowchart of one embodiment of the method according to the present invention.

FIG. 2B is a flowchart of another embodiment of the method according to the present invention.

FIG. 2C is a flowchart of a third embodiment of the method according to the present invention.

### DETAILED DESCRIPTION OF THE PREFERRED EMBODIMENTS

The present invention differentiates between pieces/parts/aspects of content. Parts or aspects of content are designated as “essential” or “auxiliary”. For example in the gaming context, the gaming engine is essential content and the data for the game such as different levels of the game, different vehicles, different characters etc. are designated as auxiliary content. In the context of interactive services, the content players and the graphical user interface (GUI) would be designated as essential. Data such as news, sports scores etc. would be designated as auxiliary. In the context of multimedia content with associated players, the multimedia players (video/audio codecs) would be essential. The multimedia content itself would be auxiliary.

In one embodiment, the service provider differentiates the content. The service provider is the entity that provides the system by which the content is distributed including the content server and the cache servers. In another embodiment, the content may be distributed to the service provider by the author/editor/content provider in differentiated form. In yet another embodiment, the users may differentiate content based on individual usage patterns via a user interface.

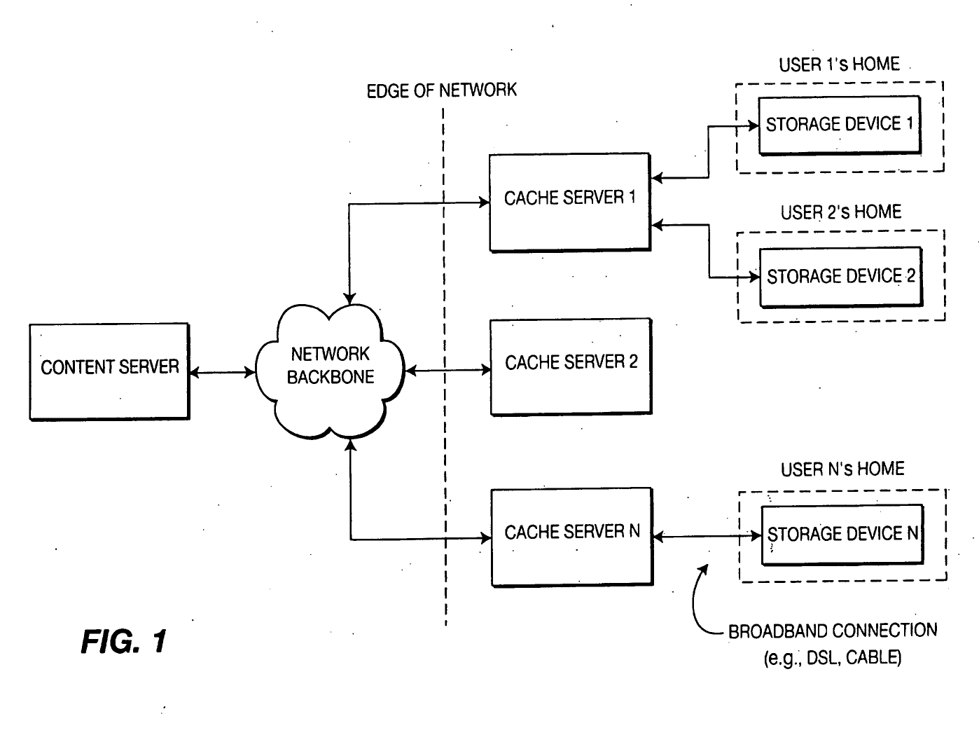

The system/network of the present invention treats/handles the different types/aspects of content differently in the caching system. The structure of the system/network is depicted in FIG. 1. There are three basic components. Content server 105, cache server 110 and a local storage device 115 at a user's/customer's home (e.g., set top box (STB), gaming console, etc.).

The content server 105 is centrally located and stores all of the essential and auxiliary content. Content server 105 may be a single computer or a cluster of computers or any equivalent arrangement used to store all of the content being offered by a provider to users/customers. There is a plurality of cache servers 110 located at the edge of the network close to the users/customers (e.g., at the DSLAM in a DSL network or the cable head end in a cable network). The storage devices 115 located in a user's/customer's home/office are connected to the closest cache server 110 and retrieve content from that cache server 110 for storage locally in their home/office. It should be noted that the local storage device may or may not be the access device that the customer uses to access the content. In one embodiment the local storage device is also the access device. In another embodiment the storage device stores the content but a home network (wired or wireless) connects to the storage device to access the content. A local storage device 115 is connected to the closest cache server 110 via a broadband connection 120 such as cable or DSL. The content server is connected to the plurality of cache servers through the network backbone 125.

If the content that is requested by the user is available on the cache server 110 then content transfer to local storage 115 begins immediately. If the requested content is not available on the closest cache server 110 then the closest cache server 110 requests the content from the content server 105. Downloading of content from the content server 105 to a cache server 110 and then from a cache server 110 to a local storage device 115 can be performed immediately using the full available bandwidth of the connection. In the alternative, downloading can be performed opportunistically over a period of time based on bandwidth availability, such as little or no downloading during peak traffic times with most of the downloading occurring during off-peak traffic time periods.

The present invention breaks the content into essential components and auxiliary components and treats/handles each component separately in terms of caching strategy. Essential content and auxiliary content are always stored at the central content server.

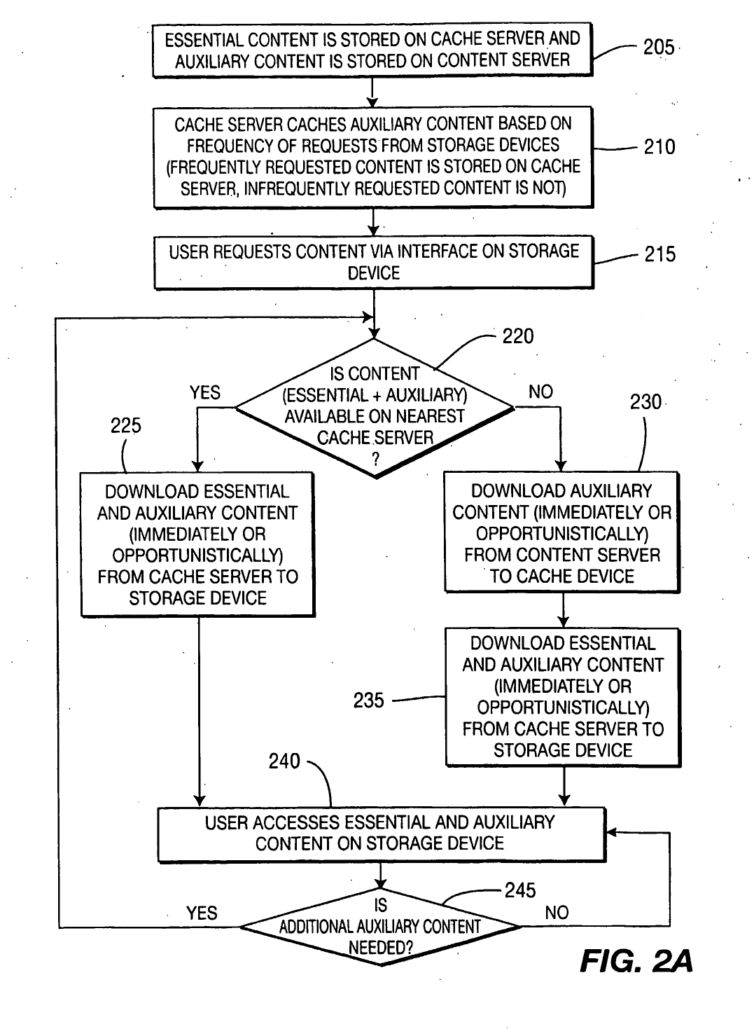

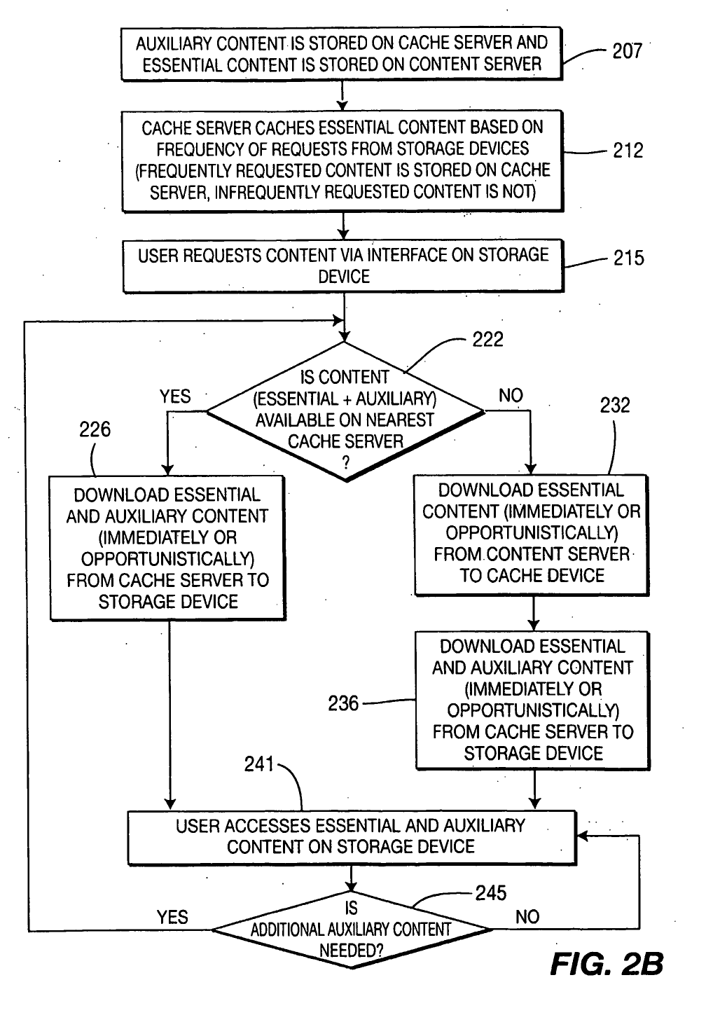

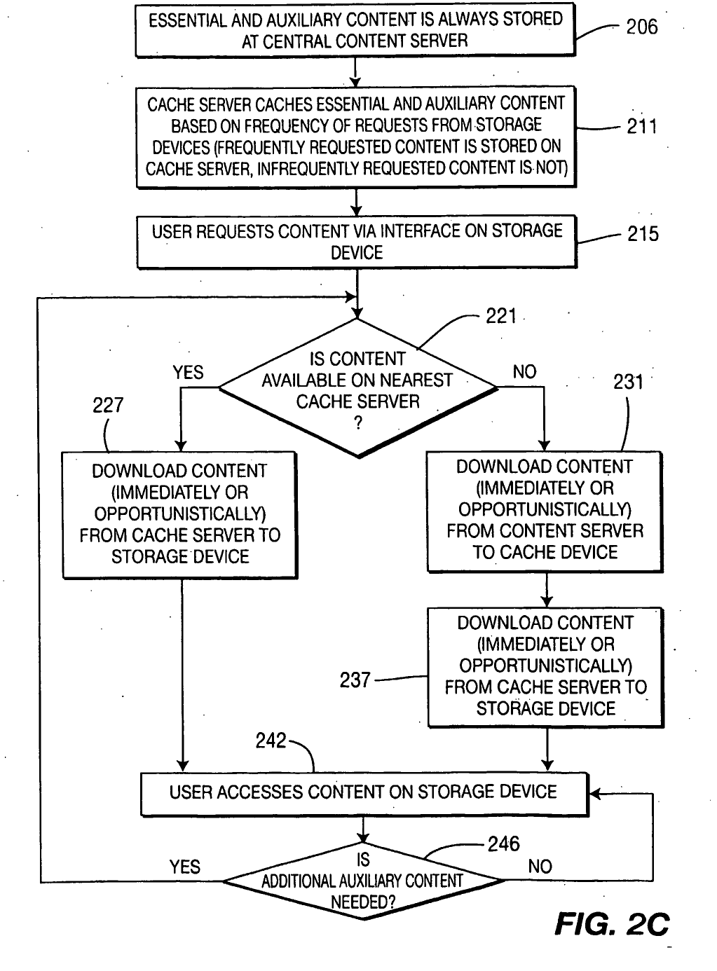

The embodiment of FIG. 2A of the present invention assumes all essential content is stored at all cache servers and auxiliary content is stored on a central content server and cached (at cache servers) as needed and based on local download requirements at steps 205 and 210. This approach assumes that the majority of users/customers will be downloading the essential content (because everyone needs those pieces of content). The downloading pattern of the auxiliary content will, however, be spread over a large number of pieces of auxiliary content. Thus the essential content is stored on all cache servers by default in order to make delivery of this frequently downloaded content as efficient as possible. Assuming that there is additional space available on the cache server, the most popular auxiliary content pieces are stored on each cache server based on the local downloading behavior. This means that each cache server might contain different pieces of auxiliary content if demand is different in different areas (e.g., geographic areas). For example, a cache server that services a young population (large apartment complex) will have different auxiliary content than a cache server that services an age restricted community. At step 215, a user requests content via an interface of a local storage device. Determination is made at step 220 if the requested content (essential and auxiliary) is available on the nearest cache server. If the requested content (essential and auxiliary) is available on the nearest cache server then the requested content is downloaded from the nearest cache server to the local storage device at step 225 either immediately or opportunistically. If the requested content is riot available on the nearest cache server then the requested content (essential and auxiliary) is downloaded from the content server to the cache server at step 230 either immediately or opportunistically. Once the requested content (essential and auxiliary) is available at the nearest cache server then the content is downloaded from the cache server to the local storage device at step 235 either immediately or opportunistically. The user then accesses the requested content (essential and auxiliary) on the local storage device at step 240. A determination is then made at step 245 if additional auxiliary content is needed. If no additional auxiliary content is needed then the user continues to access the content on the local storage device. If it is determined that additional auxiliary content is needed then the process commencing at step 220 is repeated.

In the embodiment of the present invention depicted in FIG. 2B all auxiliary content is stored at all cache servers and essential content is stored on a central content server and cached to cache servers as needed based on local download requests at step 212. That is, essential content is stored at a central content server and auxiliary content is stored on all cache servers at step 207. This approach assumes that the majority of customers will be downloading the many pieces of the auxiliary content because most people will download the essential content once (for local storage) but will download a large variety of auxiliary content. For example, customers will download a single gaming engine (essential content for all games) but they will need to download a variety of game levels and vehicles (auxiliary content) to use with that gaming engine. Thus, the most popular (including newest) auxiliary content will be stored on each cache server by default and essential cache content will be stored on each cache server as needed based on local downloading behavior. Descriptions of steps identical and numbered the same as in FIG. 2A will be omitted. At step 222, a determination is made if the requested content (essential and auxiliary) is available on the nearest cache server. If the requested content. (essential and auxiliary) is available on the nearest cache server then the requested content (essential and auxiliary) is downloaded from the nearest cache server to the local storage device at step 226 either immediately or opportunistically. If the requested content (essential) is not available on the nearest cache server then the requested content (essential) is downloaded from the content server to the cache server at step 232 either immediately or opportunistically. Once the requested content (essential and auxiliary) is available at the nearest cache server then the content is downloaded from the cache server to the local storage device at step 236 either immediately or opportunistically. The user then accesses the requested content (essential and auxiliary) on the local storage device at step 241. A determination is then made at step 245 if additional auxiliary content is needed. If no additional auxiliary content is needed then the user continues to access the content on the local storage device. If it is determined that additional auxiliary content is needed then the process commencing at step 222 is repeated.

In the embodiment of the present invention depicted in FIG. 2C essential content and auxiliary content is stored on a central content server and cached (to cache servers) on an as needed basis depending on local download requests. This approach makes no assumptions about the downloading behavior and allows the caching algorithm to decide what to store at the cache servers based solely on content popularity. By differentiating between essential and auxiliary content, the caching algorithm can adapt to local users' needs. For example, if a new game is released, the essential content (game engine) would be very popular as everyone needs to download it in order to play the game so the gaming engine would be stored on all cache servers. Some auxiliary content (e.g., the first few levels of the new game) would also be very popular and would also be stored on all the cache servers. After the game has been on the market (available) for a period of time, most people will have the essential content and it will be less popular and will be removed from the cache servers. However, later/higher levels of the game (auxiliary content) will then become popular as the user community advances in skill playing the game and that auxiliary content will be stored on the cache servers. Of course, if a new user wanted to download the game engine after the game had been available for a period of lime and, therefore, the gaming engine had been removed from the cache servers, then the download would be from the content server to a cache server to local storage at the user's home. Descriptions of steps identical and numbered the same as in FIGS. 2A and 2B will be omitted. Essential and auxiliary content is always stored on a central content server at step 206. Essential and auxiliary content is cached to cache servers on an as needed basis at step 211. At step 221, a determination is made if the requested content is available on the nearest cache server. If the content is available on the nearest cache server then the requested content is downloaded from the nearest cache server to the local storage device at step 227 either immediately or opportunistically. If the requested content is not available on the nearest cache server then the requested content is downloaded from the content server to the cache server at step 231 either immediately or opportunistically. Once the requested content is available at the nearest cache server then the content is downloaded from the cache server to the local storage device at step 237 either immediately or opportunistically. The user then accesses the requested content on the local storage device at step 242. A determination is then made at step 246 if additional auxiliary content is needed. If no additional auxiliary content is needed then the user continues to access the content in the local storage device. If it is determined that additional auxiliary content is needed then the process commencing at step 221 is repeated.

It is to be understood that the present invention may be implemented in various forms of hardware, software, firmware, special purpose processors, or a combination thereof, for example, within a mobile terminal, access point, or a cellular network. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for caching content, said method comprising:
storing content on a content server;
differentiating between pieces of content; and
storing a portion of said differentiated content at a cache server proximate to a user.

2. The method according to claim 1, further comprising:
receiving a request from a user for differentiated content stored at a proximate cache server; and
downloading said differentiated content from said proximate cache server to a local storage device of said user immediately or based on bandwidth availability.

3. The method according to claim 1, further comprising:
receiving a request from a user for differentiated content stored at said content server;
downloading said differentiated content from said content server to a proximate cache server immediately or based on bandwidth availability; and
further downloading said differentiated content from said proximate cache server to a local storage device of said user immediately or based on bandwidth availability.

4. The method according to claim 2, further comprising determining if additional differentiated content is required by said user.

5. The method according to claim 3, further comprising determining if additional differentiated content is required by said user.

6. An apparatus for caching content, comprising:
means for storing content on a content server;
means for differentiating between pieces of content; and
means for storing a portion of said differentiated content at a cache server proximate to a user.

7. The apparatus according to claim 6, further comprising:
means for receiving a request from a user for differentiated content stored at a proximate cache server; and
means for downloading said differentiated content from said proximate cache server to a local storage device of said user immediately or based on bandwidth availability.

8. The apparatus according to claim 6, further comprising:
means for receiving a request from a user for differentiated content stored at said content server;
means for downloading said differentiated content from said content server to a proximate cache server immediately or based on bandwidth availability; and
means for further downloading said differentiated content from said proximate cache server to a local storage device of said user immediately or based on bandwidth availability.

9. The apparatus according to claim 7, further comprising means for determining if additional differentiated content is required by said user.

10. The apparatus according to claim 8, further comprising means for determining if additional differentiated content is required by said user.

11. The apparatus according to claim 6, wherein said means for differentiating content is provided by a service provider.

12. The apparatus according to claim 6, wherein said means for differentiating content is provided via a user interface by a user.

13. The apparatus according to claim 6, wherein said means for differentiating content is provided by a content provider.
